(19) United States
(12) Patent Application Publication
(10) Pub. No.: US 2026/0037231 A1
(43) Pub. Date: Feb. 5, 2026

(54) FRAMEWORK INDEPENDENT CLIENT

(71) Applicant: Dell Products L.P., Round Rock, TX (US)

(72) Inventor: Ruben Michel, Hopkinton, MA (US)

(73) Assignee: Dell Products L.P., Round Rock, TX (US)

(21) Appl. No.: 18/794,155

(22) Filed: Aug. 5, 2024

(51) Int. Cl. G06F 8/30

(52) U.S. Cl. CPC G06F 8/31

(57) ABSTRACT

Systems and methods are provided for developing and maintaining a graphical user interface (GUI) client, such as a storage management client, that is independent of the set of tools, or frameworks, upon which the client is developed. A virtual framework is defined including interfaces, abstract classes relating to a selection of services. A concrete framework is provided by reifying the interfaces and abstract classes of the virtual framework. The reified concrete classes of the concrete framework are translated using structure-preserving maps to an executing framework. The mapped classes are delegated to the executing framework. The concrete framework is an adapter for the services identified in the virtual framework to one or more executing frameworks, such that when the executing framework changes, the virtual framework services remain intact.

### BACKGROUND

Web-based applications and clients rely on programming languages and web-development frameworks to build, compile and implement the client. JavaScript is a prevalent programming language popular in developing such web-based clients. TypeScript, a strongly typed variant of JavaScript, is also used in such applications. Several providers, including Microsoft, Google, Facebook (i.e., Meta) have developed graphical user interface (GUI) frameworks designed to facilitate the development of web-based clients using languages like JavaScript and TypeScript.

These GUI frameworks, however, are known to change often. Framework providers may make changes to tools, functions and code or in certain cases abandon the framework altogether. When software clients built on that framework need to change or be updated, the client may need significant recoding, refactoring, or porting to the new or changed framework. Doing so is time consuming, tedious and costly, particularly for large clients built on a large code base.

Additionally, not all framework environments are cross- or backwards-compatible, so creation or adoption of new and/or different tool sets requires client developers to rewrite code for the applications based on the now-outdated framework.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to one aspect, a method includes providing a plurality of interfaces and providing a first set of concrete classes compatible with a first framework. At least one of the first set of concrete classes may be related to at least one of the plurality of interfaces by a first mapping. A second set of concrete classes compatible with a second framework may be provided. At least one of the first set of concrete classes may be related to at least one of the second set of concrete classes by a second mapping. The at least one of the second set of concrete classes may be delegated to the second framework. The plurality of interfaces may be independent from changes to the second set of classes such that the first set of concrete classes is configured to adapt the plurality of interfaces to the changes to the second framework without changing the plurality of interfaces.

The method may further include, alone or in combination, one or more of the following features. The plurality of interfaces may include a plurality of abstract classes. The first mapping may include a reification of the plurality of interfaces to define the first set of concrete classes. The reification may include extending the plurality of interfaces to define the first set of concrete classes. The second mapping may include a functor. A first class of the second set of concrete classes may be related to a second class of the second set of concrete classes by a function. The second class of the second set of concrete classes may be related to at least one second class of the first set of concrete classes by a third functor. A first interface may be related to a second interface by a function.

According to another aspect, a system may include a memory and at least one processor that is operatively coupled to the memory. The at least one processor may be configured to perform the operations of providing a plurality of interfaces and providing a first set of concrete classes compatible with a first framework. At least one of the first set of concrete classes may be related to at least one of the plurality of interfaces by a first mapping. A second set of concrete classes compatible with a second framework may be provided. At least one of the first set of concrete classes may be related to at least one of the second set of concrete classes by a second mapping. The at least one of the second set of concrete classes may be delegated to the second framework. The plurality of interfaces may be independent from changes to the second set of classes such that the first set of concrete classes is configured to adapt the plurality of interfaces to the changes to the second framework without changing the plurality of interfaces.

The system may further include, alone or in combination, one or more of the following features. The plurality of interfaces may include a plurality of abstract classes. The first mapping may include a reification of the plurality of interfaces to define the first set of concrete classes. The reification may include extending the plurality of interfaces to define the first set of concrete classes. The second mapping may include a functor. A first class of the second set of concrete classes may be related to a second class of the second set of concrete classes by a function. The second class of the second set of concrete classes may be related to at least one second class of the first set of concrete classes by a third functor. A first interface may be related to a second interface by a function.

According to another aspect, a non-transitory computer-readable medium storing one or more processor-executable instructions, which when executed by at least one processor may cause the at least one processor to perform the operations of providing a plurality of interfaces and providing a first set of concrete classes compatible with a first framework. At least one of the first set of concrete classes may be related to at least one of the plurality of interfaces by a first mapping. A second set of concrete classes compatible with a second framework may be provided. At least one of the first set of concrete classes may be related to at least one of the second set of concrete classes by a second mapping. The at least one of the second set of concrete classes may be delegated to the second framework. The plurality of interfaces may be independent from changes to the second set of classes such that the first set of concrete classes is configured to adapt the plurality of interfaces to the changes to the second framework without changing the plurality of interfaces.

The computer-readable medium may further include, alone or in combination, one or more of the following features. The plurality of interfaces may include a plurality of abstract classes. The first mapping may include a reification of the plurality of interfaces to define the first set of concrete classes. The reification may include extending the plurality of interfaces to define the first set of concrete classes.

### BRIEF DESCRIPTION OF THE DRAWINGS

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of a storage system, according to one or more aspects of the present disclosure;

FIG. 2A is a block diagram of a client framework system, according to one or more aspects of the present disclosure;

FIG. 2B is a is a block diagram of the client framework system of FIG. 2A implementing alternative concrete and executing frameworks, according to one or more aspects of the present disclosure;

FIG. 3 is a commutative diagram, according to one or more aspects of the present disclosure;

FIG. 4 is a flow diagram of a method of implementing a framework independent client, according to one or more aspects of the present disclosure;

FIG. 5 is a diagram of an example of a computing device, according to one or more aspects of the present disclosure.

### DETAILED DESCRIPTION

Aspects of the present disclosure provide systems and methods for developing and maintaining a graphical user interface (GUI) client, such as a storage management client, that may be independent of the set of tools, or frameworks, upon which the client is developed. Relying on underlying concepts of category theory, including objects, morphisms, and functors, and object-oriented programming concepts including, interfaces, classes, objects (i.e., software objects), and the like, developed according to a first framework, may be adapted to a second framework. A virtual framework may be defined including interfaces, abstract classes and the like relating to a selection of services. A concrete framework may be provided by reifying the interfaces and abstract classes of the virtual framework. The reified concrete classes of the concrete framework may then be translated or mapped using functors to an executing framework. The mapped classes may then be delegated to the executing framework. The concrete framework serves as an adapter for the services identified in the virtual framework to one or more executing frameworks, such that when the executing framework changes, the virtual framework services remain intact.

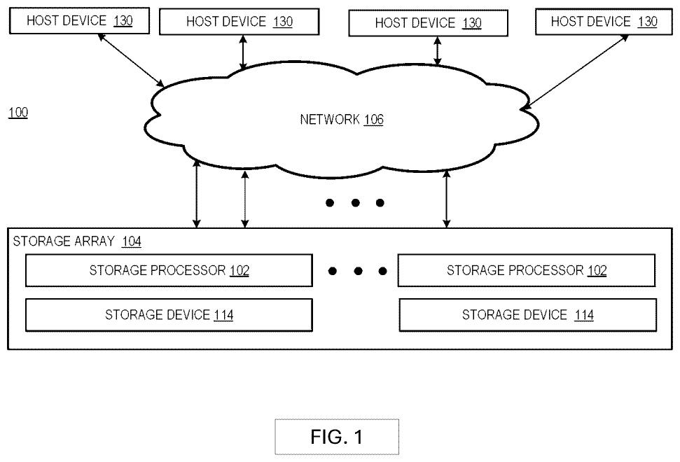

FIG. 1 is a diagram of an example of a storage system 100, according to aspects of the disclosure. As illustrated, the system 100 may include a storage array 104, a communications network 106, and a plurality of host devices 130. The communications network 106 may include one or more of a fibre channel (FC) network, the Internet, a local area network (LAN), a wide area network (WAN), and/or any other suitable type of network. The storage array 104 may include a storage system, such as DELL/EMC Powermax™, DELL PowerStore™, and/or any other suitable type of storage system. The storage array 104 may include or be arranged with one or more site-pairs and a plurality of non-volatile memory storage devices 114. Each site may be or include, as described herein, a virtual provider. Each site of the site pairs may include one or more storage processors 102. Each of the storage processors 102 may be configured to receive I/O requests from host devices 130 and execute the received I/O requests by reading and/or writing data to storage devices 114. Each of the host devices 130 may include a desktop computer, a laptop, a smartphone, an internet-of-things (IoT) device, and/or any other suitable type of computing device.

According to one aspect, each of storage devices 114 may be a non-volatile memory express (NVMe) drive. In another aspect, the storage devices may be solid-state drives (SSD). In some implementations, each of the storage devices 114 may be connected to the storage processors 102 via a Peripheral Component Interconnect Express (PCIe) connection. Each of the storage devices 114 may include a respective controller (not shown) and storage medium (not shown). The controller of each storage device 114 may include processing circuitry that is configured to perform various tasks, such as the retrieval and storage of data on the medium, wear leveling, error handling, garbage collection, as well as other functions. The medium may include an array of NAND memory cells and/or any other suitable type of storage medium.

In some implementations, any of the storage devices 114 may be internal to one of the storage processors 102 and coupled to the storage processor via an M.2 slot that is provided on the motherboard of that storage processor. Additionally, or alternatively, in some implementations, any of the storage devices 114 may be part of a disk array enclosure (DAE) and coupled to each of the storage processors 102 via a respective InfiniBand adapter of that storage processor. It will be understood that the present disclosure is not limited to any specific method for connecting storage devices 114 to storage processors 102.

According to one aspect, monitoring, controlling and maintaining storage systems, like those described above, may be accomplished using a web-based client and a server platform, for example, DELL UNISPHERE™ which includes a web-based client running on a browser and a Java EE server software. Like any software application, storage management clients often require updates and changes to implement new and/or updated services and security measures. Clients may be developed using any number of programming languages, like JavaScript, TypeScript, or the like. Within these programming languages developers may provide web application frameworks including tools and services for implementing a web-based client and GUI. When changes are made to the frameworks by their developers, changes to the client code base may be required. When an entire framework is abandoned or discontinued, client developers may be required to port some or all of the code base to a new framework platform.

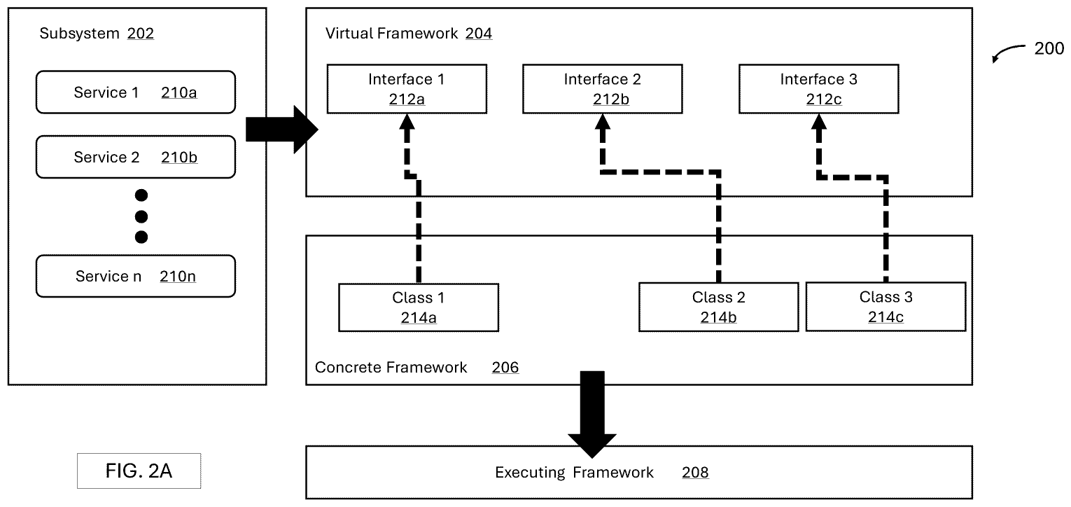

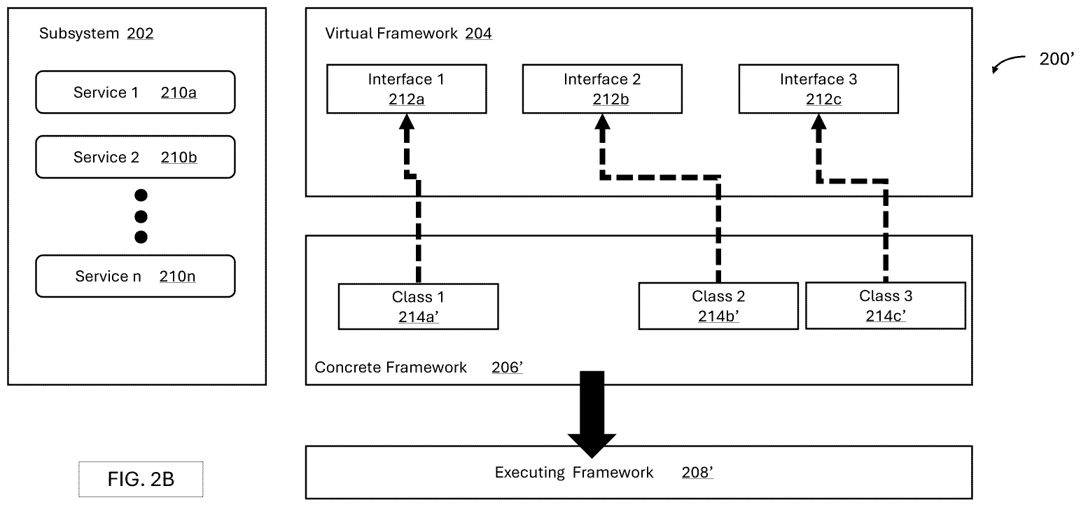

FIG. 2A is a block diagram of a client framework system 200, according to one or more aspects of the present disclosure, that insulates a number of high-level services implemented in a GUI client from changes to the underlying framework. The system 200 may include a subsystem 202, a virtual framework 204, a concrete framework 206 and an executing framework 208. As described herein the concrete framework 206 may be configured to adapt services from the subsystem 202 to one or more different executing frameworks, like executing framework 208.

According to one aspect, the subsystem 202 may be or include a library of services 210a-210n (collectively referred to as services 210) used to implement a GUI client, like a storage management client. Services 210 may include services and/or protocols relating to Logging, Q, HTTP, WebSockets, Context, or the like. According to one aspect, one or more services 210 may be identified and selected as services with sufficient commonality or importance to the client to warrant adaptability to additional frameworks. For example, logging or HTTP related services may provide sufficient commonality and importance to the implementation of the client that having to refactor or port the underlying code supporting the services to another platform is undesirable.

Accordingly, the virtual framework 204 may include or be defined by a number of interfaces or abstract classes, collectively referred to as interfaces 212, related to one or more of the services 210. Because the virtual framework is defined with only abstract interfaces, there is no implementation. In contrast, the concrete framework 206 may be entirely comprised of concrete classes, collectively referred to as concrete classes 214. According to one aspect, the interfaces 212 may be reified into the concrete classes 214, to form or define the concrete framework 206. According to one aspect, reifying the abstract interfaces 212 may include extending by inheritance the abstract interfaces 212 with corresponding classes for an executing framework 208. The executing framework may be or include a neutral platform, such as Angular, jQuery, React, Vue, Bootstrap, or the like. The concrete framework 206 may be specific to one of these frameworks. To implement the interfaces from the virtual framework 204, the concrete classes 214 may be delegated to an executing framework, like executing framework 1 208.

While the system 200 of FIG. 2A depicts a limited number of services 210a, 210b, 210n, interfaces 212a, 212b, 212c, and concrete classes 214a, 214b, 214c, one skilled in the art will recognize that the scope of the present disclosure is not limited to only that quantity of components.

According to one aspect of the present disclosure, the concrete framework 206 may be configured to adapt the services and interfaces of the virtual framework 204 for one or more executing frameworks such that if and/or when the executing framework changes, the virtual framework 204 remains unchanged and intact. For example, FIG. 2B depicts the client framework system 200 of FIG. 2B, where like reference numbers correspond to like components, with an alternative executing framework 206′ is implemented to adapt the virtual framework 204 to a second, or different framework 208′.

As shown in FIG. 2B, while the subsystem 202 and virtual framework 204 remain the same, a different concrete framework 206′ including different concrete classes 214a′, 214b′, and 214c′ (collectively concrete classes 214′), serves as an adapter between the virtual framework 204 and the executing framework 208′. In comparison to FIG. 2A, only the concrete framework 206′ and the executing framework have changed. For example, and without limitation, the framework 206 of FIG. 2A may have been developed, coded or otherwise created according to a first framework, for example Angular (i.e., an implementation of the virtual framework 204 interfaces in an Angular framework). According to one or more aspects, the executing framework 206′ of FIG. 2B may have been developed, coded or otherwise created according to another framework, like framework 208′, for example and without limitation, jQuery.

Accordingly, the concrete frameworks 206, 206′ may be interchanged at compile time according to which framework the client may be ultimately implemented. That is, if the ultimate framework for the client is Angular, for example, the client may be implemented using concrete framework 206. Whereas, for example, if the framework for the client is JQuery, a JQuery-specific concrete framework, like the concrete framework 206′, for example, may replace the concrete framework 206, and therefore at compile time, the client is generated according to the JQuery framework. In any instance, the concrete framework may change depending on the executing framework, however, the higher-level services and interfaces remain unchanged.

According to one or more aspects of the present disclosure, the virtual frameworks, concrete frameworks and executing frameworks described herein may be implemented according to one or more aspects of category theory. Category theory may be used to relate one or more objects to each other using functions, or morphisms. A category may include a number of objects and the relations between each of the objects within the category. A morphism, according to one aspect, may include a mapping between two objects within the same category. As described herein, each of the frameworks, like the virtual frameworks, the concrete frameworks and the executing frameworks, may be considered categories. Relations or functions between interfaces or classes within the same framework may be described as morphisms.

One or more categories may be related to each other by one or more functors. A functor may be considered a structure preserving mapping from one category to another. As described herein, a functor may include a mapping from one framework, such as the virtual frameworks, the concrete frameworks and the executing frameworks to another. Functors may allow each framework to implement the classes within the framework in terms of another framework. As but one example, a functor related to one or more classes defined in a concrete framework may allow for implementation of those classes in another executing framework. Continuing the illustrative example above, one or more functors may provide a mapping from one or more classes in an Angular framework to a JQuery framework. That is, the functors may provide a translation of one class defined according to one framework to a second class defined in a second framework.

Accordingly, structure-preserving mappings between interfaces and classes in one category (e.g., morphisms) and mappings of interfaces and classes between two frameworks (e.g., functors) may serve as adaptors or translators of those functions and objects across differing frameworks. According to one or more aspects, relations between the interfaces and classes within and across multiple frameworks may be expressed as a commutative diagram.

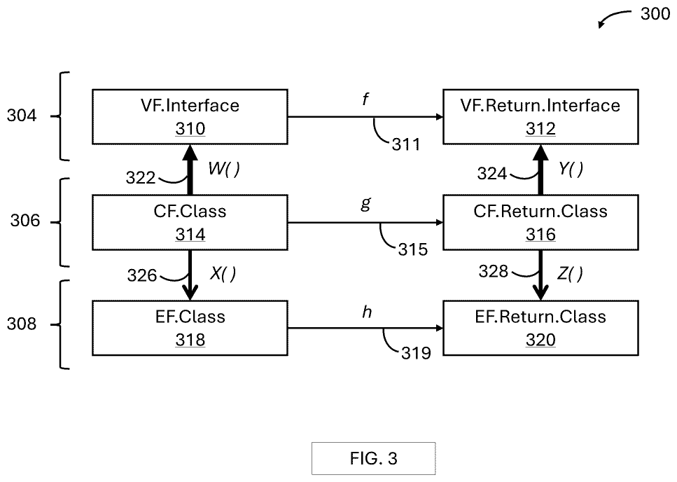

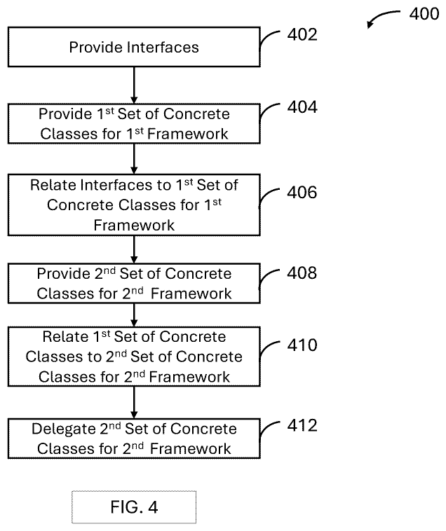

FIG. 4 is an example of a commutative diagram 300 according to one or more aspects of the present disclosure. A virtual framework 304 may include one or more interfaces such as VF.interface 310 and VF.return.interface 312. According to one aspect, VF.interface 310 may be an abstract interface, or abstract class. The VF.return.interface 312 may be, for example a return interface, of abstract class, configured to represent a response or return to an invocation or method of VF.interface 312. For example, without limitation and presented for ease of explanation, VF.interface 310 may include or be an abstract class defining an HTTP request. Accordingly, VF.return.interface 312 may then be a return class defined as a response or return class to the HTTP request. As shown in FIG. 3, the relation between the two interfaces may be described as a morphism, f, represented by arrow 311.

A concrete framework 306 may include one or more concrete classes, including CF.class 314 and CF.return.class 316. The concrete class CF.class 314 may be a reification of the abstract interface, VF.interface 310. According to one aspect, CF.class 314 may use inheritance to reify (e.g., extend) the virtual framework interface VF.interface 310. Similarly, CF.return.class 316 may extend VF.return.interface 312 into a concrete class. Within the concrete framework, CF.class 314 may return CF.return.class 316 after an invocation of the CF.class 314. As shown in FIG. 3, CF.class 314 and CF.return.class 316 may be related according to a morphism g, indicated by arrow.

The reification of the VF.interface 310 (e.g., extending the abstract interface into a concrete class) into the CF.class 314 may be considered a structure-preserving mapping, or functor, W( ), indicated by arrow 322, between the categories of the virtual framework 304 and the concrete framework 306. Similarly, the VF.return.interface 312 being extended to a concrete class, CF.return.class 316 may be considered a structure-preserving mapping, or functor Y( ), indicated by arrow 324, extending the interface into a concrete class. The mappings W( ) and Y( ) preserve the structure of the interfaces from the virtual framework 304 to the concrete framework 306.

The concrete framework 304 may be configured to translate or adapt the interfaces and abstract classes defined in the virtual framework 304 into classes compatible with a second framework, such as the executing framework 308. For example, an abstract class, like one configured to make an HTTP request, may be defined according to a first framework, however that class definition may not be compatible with the executing framework 304. As shown in the diagram of FIG. 3, for example, the CF.class 314 may be configured to translate the VF.interface 310 into a concrete class that is compatible or readily understandable to the executing framework 308. Accordingly, the CF.class 314 may be mapped to EF.class 318 in the executing framework 308 according to a structure-preserving mapping, or functor X( ), indicated by arrow 326. Similarly, CF.return.class 316 may be mapped to EF.return.class 320 according to a structure-preserving mapping, or functor Z( ), as indicated by arrow 328. Like in the other frameworks, EF.class 318 may be defined to return EF.return.class 320 according to the relation, or morphism h, indicated by arrow 319.

According to one aspect, as indicated by the commutative diagram 300, a framework-independent client may be created such that services may be implemented in a virtual framework 304, extended to a concrete framework 306, translated or mapped to a executing framework and delegated to that framework. As explained herein, changes to the underlying executing framework 308 may occur without having to refactor or recode the interfaces defined in the virtual interface 304.

In sum, taking the exemplary system shown in FIG. 3, VF.interface 310 may return the VF.return.interface 312 following an invocation. At the concrete framework 304, CF.class 314 may return a CF.return.class after the same invocation. In the executing framework 308, the EF.class 318 may return the EF.return.class 320 after that same invocation. As indicated in FIG. 3, the concrete framework 304 may use class inheritance to reify the interfaces of the virtual framework 302. Accordingly, CF.class 314 extends VF.interface 310 and similarly CF.return.class 316 extends VF.return.interface 312. According to one aspect, the concrete framework uses delegation to invoke the executing framework 304. Thus, CF.class 314 may invoke EF.class 318 and CF.return.class 318 may invoke EF.return.class 320.

Referring now to FIG. 4, a flow diagram of a method 400 of implementing a framework independent client is shown according to one or more aspects of the present disclosure. As disclosed herein, services related to implementation and development of a web-based client may be identified for abstraction to a virtual framework. According to one aspect, services may include, without limitation, one or more of Logging, http, WebSockets, Q, Context, Promise, or the like. As shown in block 402, one or more interfaces associated with the identified services may be provided to define the virtual framework. As shown in block 404, a first set of concrete classes compatible with a first framework (e.g., JQuery, Vue, Bootstrap, etc.) may be provided. The first set of concrete classes may correspond to each of, or one or more of, the interfaces of the virtual framework. As shown in block 406, the first set of interfaces may be related to each of the first set of concrete classes according to a first structure-preserving mapping. According to one embodiment, and described herein, the mapping of the interfaces to the first set of concrete classes may be by extension or inheritance of each interface to a concrete class.

As shown in block 408, a second set of concrete classes compatible with a second framework may be provided, for example a framework different from the first framework (e.g., JQuery, Vue, Bootstrap, etc.). As shown in block 410 the first set of concrete classes may be related to the second set of concrete classes by a second structure preserving mapping, or functor. As shown in block 412, the concrete classes for the second framework may be delegated to the framework. As described herein the plurality of interfaces may be independent from changes to the second set of concrete classes such that the first set of concrete classes is configured to adapt the plurality of interfaces to any changes made to the second framework without changing the plurality of interfaces.

While the aspects of the present disclosure may be described in the context of certain services, interfaces, objects and/or classes, one skilled in the art will recognize that the disclosure is not limited to the illustrative examples given. Further, while the aspects described herein may be described in the context of a JavaScript or TypeScript language, and certain web-development frameworks, one skilled on the art will further recognize that the aspects described herein are not limited to one implementation, programming language or development framework.

Further, while the diagrams and descriptions herein may show a one-to-one correspondence, and/or mapping between interfaces classes and the like, one skilled in the art will recognize that the structure-preserving mappings, including functors and morphisms, need not be one-to-one, but other dimensionalities are possible without deviating from the scope of the present disclosure.

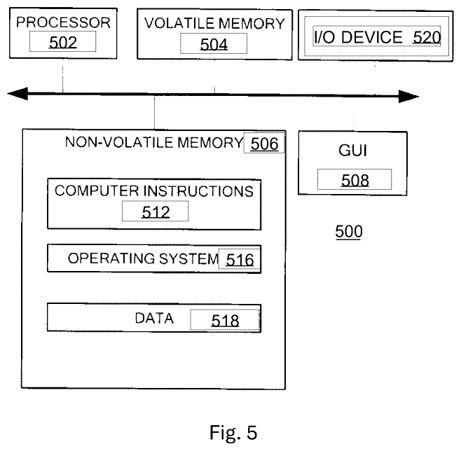

Referring to FIG. 5, in some embodiments, a computing device 500 may include processor 502, volatile memory 504 (e.g., RAM), non-volatile memory 506 (e.g., a hard disk drive, a solid-state drive such as a flash drive, a hybrid magnetic and solid-state drive, etc.), graphical user interface (GUI) 508 (e.g., a touchscreen, a display, and so forth) and input/output (I/O) device 520 (e.g., a mouse, a keyboard, etc.). Non-volatile memory 506 stores computer instructions 512, an operating system 516 and data 518 such that, for example, the computer instructions 512 are executed by the processor 502 out of volatile memory 504. Program code may be applied to data entered using an input device of GUI 508 or received from I/O device 520.

FIGS. 1-5 are provided as an example only. In some aspects or embodiments, the term “I/O request” or simply “I/O” may be used to refer to an input or output request. In some embodiments, an I/O request may refer to a data read or write request. At least some of the steps discussed with respect to FIGS. 1-5 may be performed in parallel, in a different order, or altogether omitted. As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used throughout the disclosure, the term “vector” refers to a sequence of numbers (and/or other elements). The phrase “the element having index i” refer to the i-th element in the sequence. For example, if i=1, the phrase i-th element in the sequence would refer to the first element in the sequence, if i=2, the phrase i-th element in the sequence would refer to the second element in the sequence, and so forth.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

What is claimed is:

1. A method comprising:
providing a plurality of interfaces;
providing a first set of concrete classes compatible with a first framework;
relating at least one of the first set of concrete classes to at least one of the plurality of interfaces by a first mapping;
providing a second set of concrete classes compatible with a second framework;
relating at least one of the first set of concrete classes to at least one of the second set of concrete classes by a second mapping; and
delegating the at least one of the second set of concrete classes to the second framework;
wherein the plurality of interfaces is independent from changes to the second set of classes such that the first set of concrete classes is configured to adapt the plurality of interfaces to the changes to the second framework without changing the plurality of interfaces.

2. The method of claim 1 wherein the plurality of interfaces comprises a plurality of abstract classes.

3. The method of claim 1 wherein the first mapping is a reification of the plurality of interfaces to define the first set of concrete classes.

4. The method of claim 3 wherein the reification includes extending the plurality of interfaces to define the first set of concrete classes.

5. The method of claim 1 wherein the second mapping comprises a functor.

6. The method of claim 1 further comprising relating a first class of the second set of concrete classes to a second class of the second set of concrete classes by a function.

7. The method of claim 6 further comprising relating the second class of the second set of concrete classes to at least one second class of the first set of concrete classes by a third functor.

8. The method of claim 1 further comprising relating a first interface to a second interface by a function.

9. A system comprising:
a memory; and
at least one processor that is operatively coupled to the memory, the at least one processor being configured to perform the operations of:
providing a plurality of interfaces;
providing a first set of concrete classes compatible with a first framework;
relating at least one of the first set of concrete classes to at least one of the plurality of interfaces by a first mapping;
providing a second set of concrete classes compatible with a second framework;
relating at least one of the first set of concrete classes to at least one of the second set of concrete classes by a second mapping; and
delegating the at least one of the second set of concrete classes to the second framework;
wherein the plurality of interfaces is independent from changes to the second set of classes such that the first set of concrete classes is configured to adapt the plurality of interfaces to the changes to the second framework without changing the plurality of interfaces.

10. The system of claim 9 wherein the plurality of interfaces comprises a plurality of abstract classes.

11. The system of claim 9 wherein the first mapping is a reification of the plurality of interfaces to define the first set of concrete classes.

12. The system of claim 11 wherein the reification includes extending the plurality of interfaces to define the first set of concrete classes.

13. The system of claim 9 wherein the second mapping comprises a functor.

14. The system of claim 9 further comprising relating a first class of the second set of concrete classes to a second class of the second set of concrete classes by a function.

15. The system of claim 14 further comprising relating the second class of the second set of concrete classes to at least one second class of the first set of concrete classes by a third functor.

16. The system of claim 9 further comprising relating a first interface to a second interface by a function.

17. A non-transitory computer-readable medium storing one or more processor-executable instructions, which when executed by at least one processor cause the at least one processor to perform the operations of:
providing a plurality of interfaces;
providing a first set of concrete classes compatible with a first framework;
relating at least one of the first set of concrete classes to at least one of the plurality of interfaces by a first mapping;
providing a second set of concrete classes compatible with a second framework;
relating at least one of the first set of concrete classes to at least one of the second set of concrete classes by a second mapping; and
delegating the at least one of the second set of concrete classes to the second framework;
wherein the plurality of interfaces is independent from changes to the second set of classes such that the first set of concrete classes is configured to adapt the plurality of interfaces to the changes to the second framework without changing the plurality of interfaces.

18. The non-transitory computer-readable medium of claim 17 wherein the plurality of interfaces comprises a plurality of abstract classes.

19. The non-transitory computer-readable medium of claim 17 wherein the first mapping is a reification of the plurality of interfaces to define the first set of concrete classes.

20. The non-transitory computer-readable medium of claim 19 wherein the reification includes extending the plurality of interfaces to define the first set of concrete classes.
